(19) United States
(12) Patent Application Publication
(10) Pub. No.: US 2006/0289725 A1
(43) Pub. Date: Dec. 28, 2006

(54) Optical image acquisition method adapted to laser optical mouse

(76) Inventor: Chi-Wang Tsen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/236,504

(22) Filed: Sep. 28, 2005

(30) Foreign Application Priority Data
Jun. 28, 2005 (TW) 94121685

(51) Int. Cl. G06M 7/00; H01J 40/14

(52) U.S. Cl. 250/221; 250/222.1

(57) ABSTRACT

An optical image acquisition method adapted to a laser optical mouse, which makes optical input devices work on transparent media, in which the method generates a laser light and projects it in a vertical direction. The laser light is directed to an optical device and transmitted to an image-contacting surface under a transparent medium. Image signals acquired on the image-contacting surface are reflected to the optical device, and then a laser light beam of the image signals is reflected to an image acquisition element.

### BACKGROUND OF THE INVENTION

1. Field of the Invention

The present invention relates to an optical image acquisition method adapted to a laser optical mouse, and especially relates to a method for acquiring correct images from a transparent medium to a laser optical mouse.

2. Description of Related Arts

A prior art mouse includes an X-axis encoder and a Y-axis encoder with output logic sequence signals (ex. 11, 10, 00, 01). The mouse is placed on the top surface of a desk or another surface and moved in designated directions to move a cursor on a monitor in a corresponding manner. The movement of the cursor on the monitor made by the mouse adopts a principle that the X-axis and the Y-axis encoder together produce control signals to move the cursor.

Reference is made to FIG. 1A and FIG. 1B, which illustrate cutaway views of prior art optical mice, respectively. When the prior art mouse is moved on a plane, a circuit control unit (not shown) will calculate the distance and direction of the movement of the mouse by the following steps:

1. Light emitted from a light-emitting element 61 is projected to a first reflection surface 621 of a transparent plate 62;

2. The light is then reflected to a second surface 622;

3. The second surface 622 reflects the light onto a contact surface 64 made of a non-transparent interface through an opening of a bottom shell 63, in which an image axis F overlaps with the contact surface 64 when the contact surface 64 is a non-transparent interface;

4. A lens 65 focuses image signals of the image axis F onto an image acquisition element 66; and

5. The image signals are transferred to the circuit control unit for processing.

A light beam D of the projected light must be intersected at a point P of the image-contacting surface 64 with an image-acquisition light beam R and an image axis F; therefore, the image acquisition element 66 can retrieve the image on the image axis F.

If the image-contacting surface 64 is made of a transparent medium such as glass, the image axis F does not overlap with the image-contacting surface 64. The light beam D of the projected light may intersect with an image axis F1 (at a point M under the image-contacting surface 64 (the refraction effect is not taken into account here). Meanwhile, the light beam D and the image-acquisition light beam R cannot intersect with the image axis F of the image-contacting surface 64, as FIG. 1B shows. The optical mouse therefore doesn't work on a transparent medium.

Hence, prior art mice must reflect the light emitted from the light-emitting element 61 twice to the image-contacting surface 64, and this wastes power. Moreover, when the laser beam is projected through the optical mouse, the user's eyes are easily harmed by the laser beam. Furthermore, in prior art, the lens 65 matches with the image acquisition element 66 for acquiring images. Hence, the image acquisition element 66 cannot acquire images by itself without using the lens 65, and the lens 65 not only increases the cost, but also increases the whole volume of the optical mouse.

FIG. 2 shows a cross-sectional view of an optical mouse according to a second prior art. Firstly, a laser beam L is projected from a laser light-emitting element 1a, and the laser beam L is projected onto a contact surface 3a via a prism 2a for acquiring images. Afterward, the laser beam L with images is reflected from the contact surface 3a to an image lens 4a. Finally, the laser beam L with the images is projected to a sensor array 5a via the image lens 4a for finishing the action of acquisition images.

Furthermore, FIG. 3 shows a cross-sectional view of an optical mouse according to a third prior art. The principle of FIG. 3 is the same as that of FIG. 2. Firstly, a laser beam L is projected from a laser light-emitting element 1b, and the laser beam L is projected onto a contact surface 3b via a lens 2b for acquiring images. Afterward, the laser beam L with images is reflected from the contact surface 3b to the lens 2b. Finally, the laser beam L with the images is projected to a sensor 4b via the lens 2b for finishing the action of acquisition images.

Hence, it is obvious that laser beam L is easily projected outside the optical mouse and as such can cause harm to the user's eyes. Moreover, the sensor array 5a or the sensor 4b cannot acquire images by itself without using the image lens 4a or the lens 2b, and the lens 65 not only increases the cost of the product, but also increases the whole volume of the optical mouse.

FIG. 4 shows a schematic view of an optical mouse according to fourth prior art. The optical mouse provides an optical image acquisition method as the following steps outline:

1. Generating light via a light-emitting element 1c, and the light propagating along a light beam d in a vertical direction;

2. Transmitting light with a light beam d to a surface of an optical device 2c, wherein the vertical light beam d is split into reflected light and transmitted light by the optical device 2c;

3. Transmitting the transmitted light with a light beam d1 to an image-contacting surface 31c under a transparent medium 3c for producing image signals;

4. Reflecting the image signals from the image-contacting surface 31c to an internal surface of the optical device 2c along an image acquisition light beam r, wherein the image acquisition light beam r overlaps with the light beam d1 of the transmitted light; and

5. Reflecting the image signals from the optical device 2c to a lens 4c along an image light beam r1, wherein the lens 4 can be used to focus the light of the image signals onto an image acquisition element 5c.

Because the light beam d1 and the image acquisition light beam r overlap and intersect with a point p of the image-contacting surface 31c, images can be correctly acquired by the image acquisition element 5c.

FIG. 5 shows a schematic view of an optical mouse according to a fifth prior art. The optical mouse provides an optical image acquisition method as following steps:

1. Generating light via a light-emitting element 1c, the light propagating along a light beam d in a horizontal direction;

2. Transmitting the light with a light beam d to a surface of an optical device 2c, wherein the light can be split into reflected light and transmitted light by the optical device 2c;

3. Transmitting the transmitted light with a light beam d1 to an image-contacting surface 31c under a transparent medium 3c for producing image signals;

4. Reflecting the image signals from the image-contacting surface 31c to an internal surface of the optical device 2c along an image acquisition light beam r, wherein the image acquisition light beam r overlaps with the light beam d1 of the transmitted light; and

5. Transmitting the image signals from the optical device 2 to a lens 4c along an image light beam r1, wherein the lens 4c is used to focus the light of the image signals to an image acquisition element 5c.

Because the light beam d1 and the image acquisition light beam r overlap and intersect with a point p of the image-contacting surface 31c, images can be correctly acquired by the image acquisition element 5c.

FIG. 6 shows a schematic view of an optical mouse according to a sixth prior art. The optical mouse provides an optical image acquisition method as outlined in the following steps:

1. Generating light via a light-emitting element 1c, the light propagating along a light beam d in a vertical direction;

2. Transmitting the light with a light beam d to a surface of an optical device 6c, wherein the incident light can be split into reflected light and transmitted light by the optical device 6c;

3. Transmitting the transmitted light along a light beam d1 to an image-contacting surface 31c under a transparent medium 3c for producing image signals;

4. Reflecting image signals from the image-contacting surface 31c to the optical device 6c along the an image acquisition light beam r, wherein the acquisition light beam r overlaps with the light beam d1 of the reflected light;

5. Reflecting the image signals from the optical device 6c to a reflecting mirror 6′c along an image light beam r1; and

6. Reflecting the image signals from the reflecting mirror 6′c to a lens 4 along an image light beam r2, wherein the lens 4 is used to focus the light of the image signals to an image acquisition element 5.

Because the light beam d1 and the image acquisition light beam r overlap and intersect with a point p of the image-contacting surface 31c, images signals can be correctly acquired by the image acquisition element 5c.

FIG. 7 shows a schematic view of an optical mouse according to seventh prior art. The optical mouse provides an optical image acquisition method as outlined in the following steps:

1. Generating light via a light-emitting element 1c and the light propagating along a light beam d in a vertical direction;

2. Transmitting the light with a light beam d to a surface of a reflection mirror 8′c;

3. Transmitting the light reflected from the reflection mirror 8′c to an optical device 8c along a light beam d1, wherein the incident light can be split into reflected light and transmitted light by the optical device 8;

4. Transmitting the reflected light along a light beam d2 to an image-contacting surface 31c under a transparent medium 3c for producing image signals;

5. Reflecting image signals from the image-contacting surface 31c to the optical device 8c, wherein the image acquisition light beam r overlaps with the light beam d2 of the reflected light; and

6. Transmitting the light from the optical device 8c to a lens 4c along an image light beam r1, wherein the lens 4 is used to focus the light of image signals to an image acquisition element 5c.

Because the light beam d2 and the image acquisition light beam r overlap and intersect with a point p of the image-contacting surface 31c, images can be acquired by the image acquisition element 5c.

FIG. 8 shows a schematic view of an optical mouse according to an eighth prior art. The optical mouse provides an optical image acquisition method as outlined in the following steps:

1. Generating light via a light-emitting element 1c and the light propagating along a light beam d in a vertical direction;

2. Transmitting the light with a light beam d to a lens unit 7c;

3. Transmitting the light with the light beam d1 from the lens unit 7c to an image-contacting surface 31c under a transparent medium 3c for producing image signals;

4. Reflecting image signals from the image-contacting surface 31c to the lens unit 7c, wherein an image acquisition light beam r overlaps with the light beam d1; and

5. Transmitting the light reflected twice by the lens 7c to a lens 4c, wherein the lens 4c is used to focus the light of the image signals to an image acquisition element 5c.

Because the light beam d1 and the image acquisition light beam r overlap and intersect with a point P of the image-contacting surface 31c, images can be acquired correctly by the image acquisition element 5c.

FIG. 9 shows a schematic view of an optical mouse according to a ninth prior art. The optical mouse provides an optical image acquisition method, and it provides the following steps as outlined below:

1. Generating light via a light-emitting element 1c and a light beam d in a vertical direction;

2. Transmitting the light with the light beam d to a lens unit 9c to be reflected twice;

3. Transmitting the light with a light beam d2 to an image-contacting surface 31c under a transparent medium 3c;

4. Reflecting the image signals from the image-contacting surface 31c to the lens unit 9c, wherein an image acquisition light beam r overlaps with the light beam d2; and

5. Transmitting the light with an image light beam r1 to a lens 4c, wherein the lens 4c is used to focus the light of the image signals to an image acquisition element 5c.

Because the light beam d2 and the image acquisition light beam r overlap and intersect with a point P of the image-contacting surface 31c, images can be acquired by the image acquisition element 5c.

Hence, it is obvious that the image acquisition element 5c cannot acquire images by itself without using the lens 4c according to FIGS. 4 to 9, and the lens 4c not only increases the cost, but also increases the whole volume of the optical mouse.

### SUMMARY OF THE INVENTION

A first object of the present invention is to provide an image acquisition method for optical mice on a transparent medium.

A second object of the present invention is to provide an optical mouse, which can lower power use of a light source in an optical mouse. Because light for the light source can be emitted to the transparent medium via the shortest possible route, power use by the light source can be reduced.

A third object of the present invention is to provide an optical device, a reflecting mirror or a lens unit to decrease the intensity of the laser light beam for lessening the damaging effects to a user's eyes when user looks steadily at the laser light beam.

A fourth object of the present invention is to provide an image acquisition element having a compact sensor array. Hence, the image acquisition element can be used to acquire images by itself without using any lenses to focus image signals as in the prior art, thereby reducing costs.

A first aspect of the invention is an optical image acquisition method adapted to a laser optical mouse for detecting image signals reflected from an image-contacting surface under a medium. The method comprising the following steps: generating a laser light projected in a vertical direction; transmitting the laser light to an optical device; transmitting the laser light through the optical device and transmitting a transmitted laser light passing through the optical device to the image-contacting surface under the medium for producing the image signals; reflecting the image signals to the optical device along an image acquisition laser light beam, wherein the image acquisition laser light beam overlaps with a laser light beam of the transmitted laser light; and reflecting the image signals returned from the image-contacting surface to an image acquisition element.

A second aspect of the invention is an optical image acquisition method adapted to laser optical mouse, comprising: generating a laser light and projecting the laser light in a vertical direction; transmitting the laser light to an optical device; transmitting the laser light reflected by the optical device at least once to an image-contacting surface under a medium; reflecting the image signals to the optical device, wherein an image acquisition laser light beam overlaps with a laser light beam of laser light reflected by the optical device; and transmitting the image signals returned from the image-contacting surface to an image acquisition element.

A third aspect of the invention is an optical image acquisition method adapted to laser optical mouse, comprising: generating a laser light and projecting the laser light in a horizontal direction; transmitting the laser light to an optical device; transmitting the laser light reflected by the optical device to an image-contacting surface under a medium; reflecting image signals onto the optical device, wherein an image acquisition laser light beam overlaps with a laser light beam of laser light reflected by the optical device; and transmitting image signals returned from the image-contacting surface to an image acquisition element.

A second/fourth aspect of the invention is an optical image acquisition method adapted to laser optical mouse, comprising: generating a laser light and projecting the laser light in a horizontal direction; transmitting the laser light to a lens unit; transmitting the laser light reflected by the lens unit twice to an image-contacting surface under a medium; reflecting image signals to the lens unit, wherein an image acquisition laser light beam overlaps with the laser light beam of the laser light reflected twice by the lens unit; and transmitting the laser light returned from the image-contacting surface to an image acquisition element.

### BRIEF DESCRIPTION OF THE DRAWINGS

The various objects and advantages of the present invention will be more readily understood from the following detailed description when read in conjunction with the appended drawing, in which:

FIG. 1A is a cross-sectional view of an optical mouse according to one embodiment of a first prior art;

FIG. 1B is a cross-sectional view of an optical mouse according to another embodiment of a first prior art;

FIG. 2 is a cross-sectional view of an optical mouse according to a second prior art;

FIG. 3 is a cross-sectional view of an optical mouse according to a third prior art;

FIG. 4 is a schematic view of an optical mouse according to a fourth prior art;

FIG. 5 is a schematic view of an optical mouse according to a fifth prior art;

FIG. 6 is a schematic view of an optical mouse according to a sixth prior art;

FIG. 7 is a schematic view of an optical mouse according to a seventh prior art;

FIG. 8 is a schematic view of an optical mouse according to an eighth prior art;

FIG. 9 is a schematic view of an optical mouse according to a ninth prior art;

FIG. 10 is a schematic view of the first embodiment according to the present invention;

FIG. 11 is a flowchart of the first embodiment according to the present invention;

FIG. 12 is a schematic view of the second embodiment according to the present invention;

FIG. 13 is a flowchart of the second embodiment according to the present invention;

FIG. 14 is a schematic view of the third embodiment according to the present invention;

FIG. 15 is a flowchart of the third embodiment according to the present invention;

FIG. 16 is a schematic view of the fourth embodiment according to the present invention;

FIG. 17 is a flowchart of the fourth embodiment according to the present invention;

FIG. 18 is a schematic view of the fifth embodiment according to the present invention;

FIG. 19 is a flowchart of the fifth embodiment according to the present invention;

FIG. 20 is a schematic view of the sixth embodiment according to the present invention; and

FIG. 21 is a flowchart of the sixth embodiment according to the present invention.

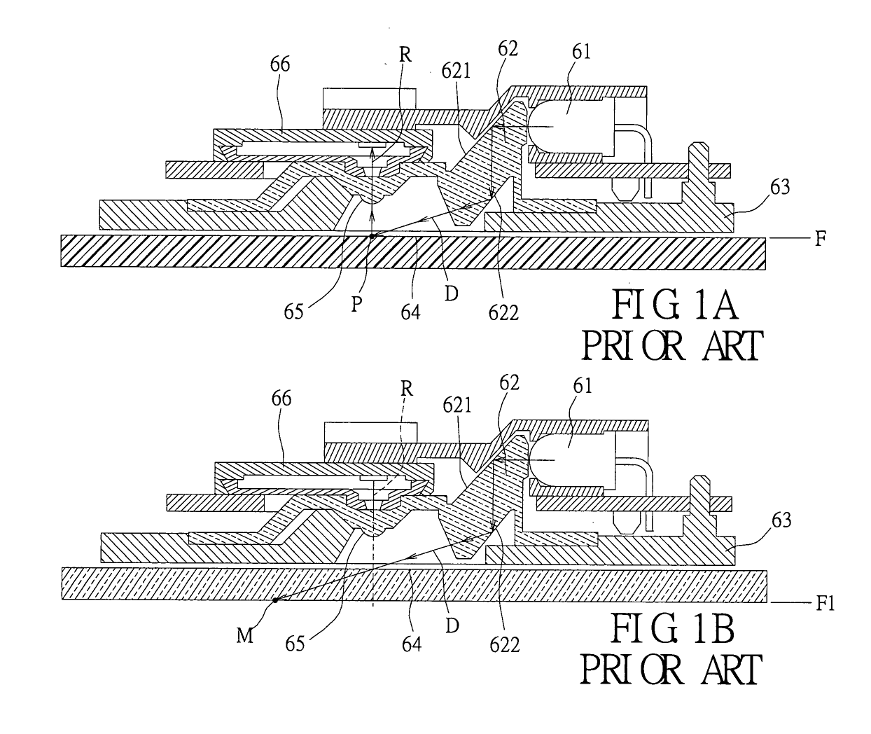

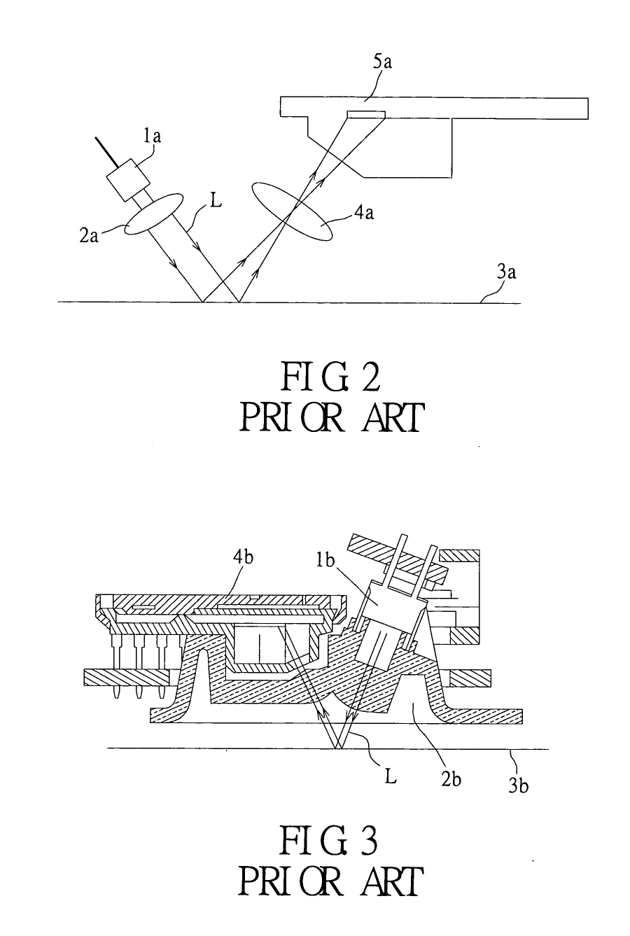

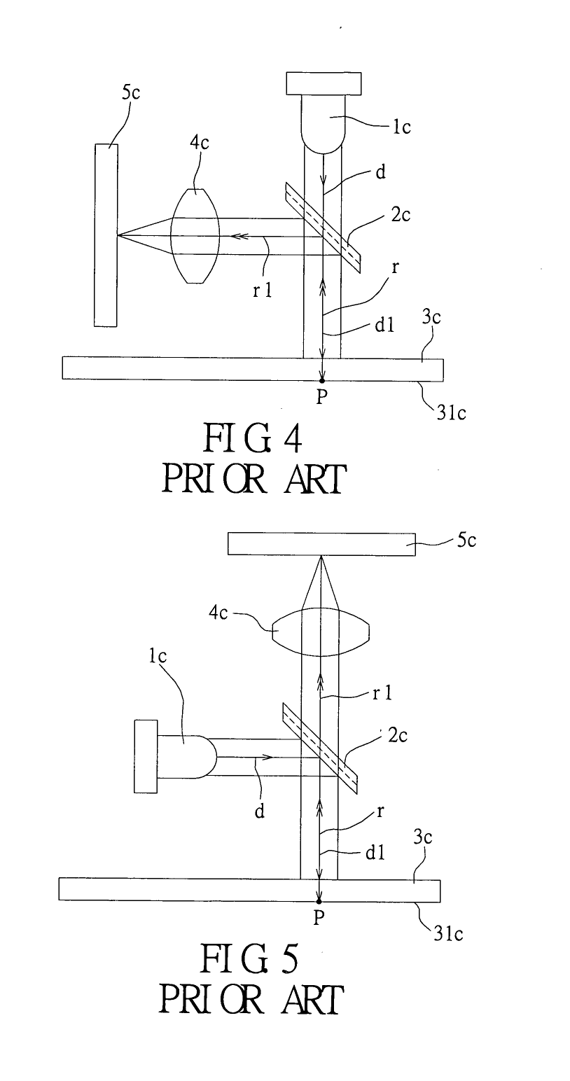

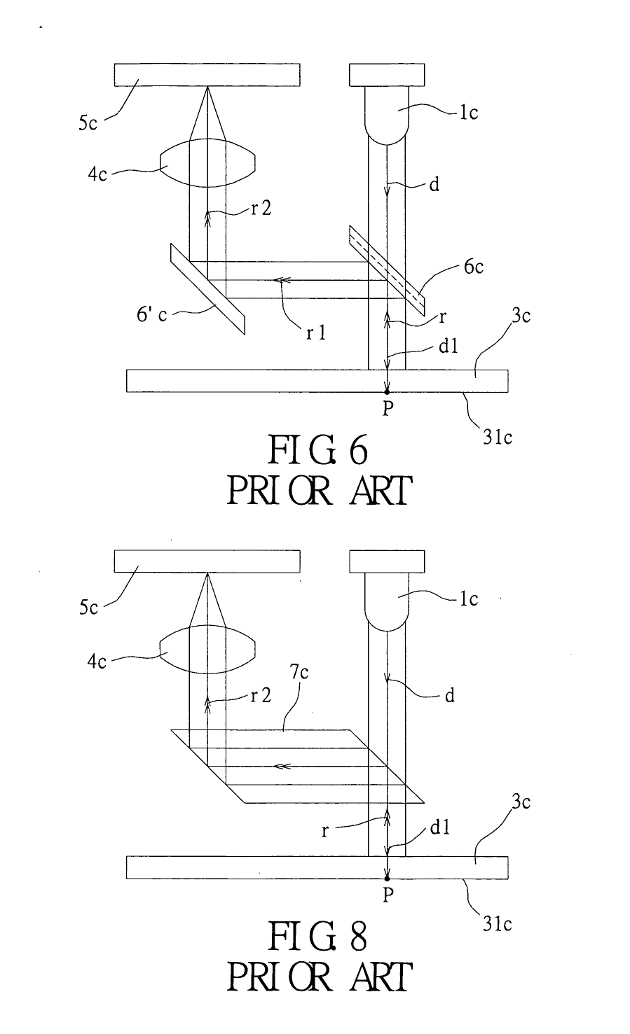

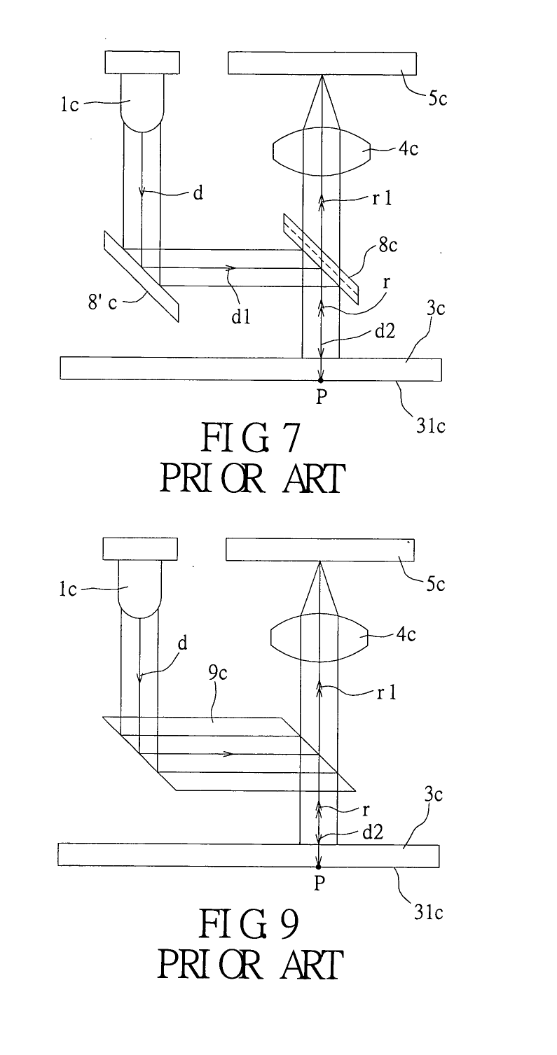

### DETAILED DESCRIPTION OF PREFERRED EMBODIMENTS

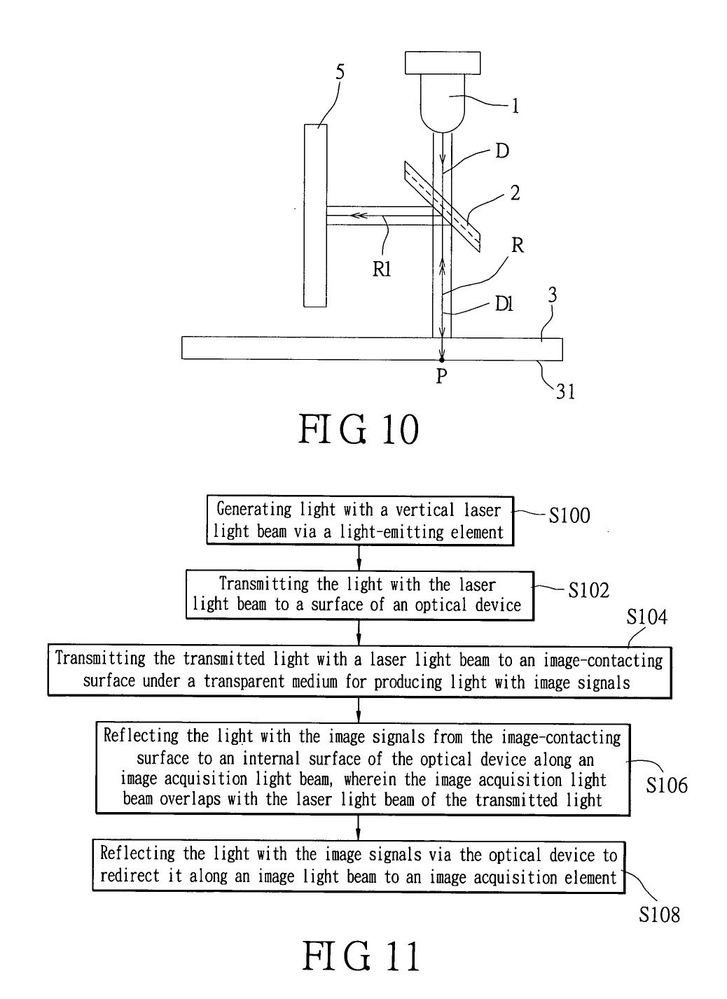

FIGS. 10 and 11 show is a schematic view and a flowchart of the first embodiment according to the present invention, respectively. The first embodiment shows an optical image acquisition method, as outlined below:

1. Generating light with a vertical laser light beam D via a light-emitting element 1 (S100), wherein the light-emitting element 1 can be a light-emitting diode;

2. Transmitting the light with the laser light beam D to a surface of an optical device 2 (S102), wherein the light is split into reflected light and transmitted light by the optical device 2;

3. Transmitting the transmitted light with a laser light beam D1 to an image-contacting surface 31 under a transparent medium 3 for producing light with image signals (S104), wherein the transparent medium can be glass;

4. Reflecting the light with the image signals from the image-contacting surface 31 to an internal surface of the optical device 2 along an image acquisition light beam R, wherein the image acquisition light beam R overlaps with the laser light beam D1 of the transmitted light (S106); and

5. Reflecting the light with the image signals via the optical device 2 to redirect it along an image light beam R1 to an image acquisition element 5 (S108), wherein the image acquisition element 5 can be a CCD or CIS.

Because the laser light beam D1 and the image acquisition laser light beam R overlap and intersect with a point P of the image-contacting surface 31, images can be correctly acquired by the image acquisition element 5.

Therefore, optical devices may operate normally on transparent media and the image acquisition element 5 can retrieve the images reflected from the transparent media 3. Furthermore, movement and directions made by the optical mouse are calculated by control units.

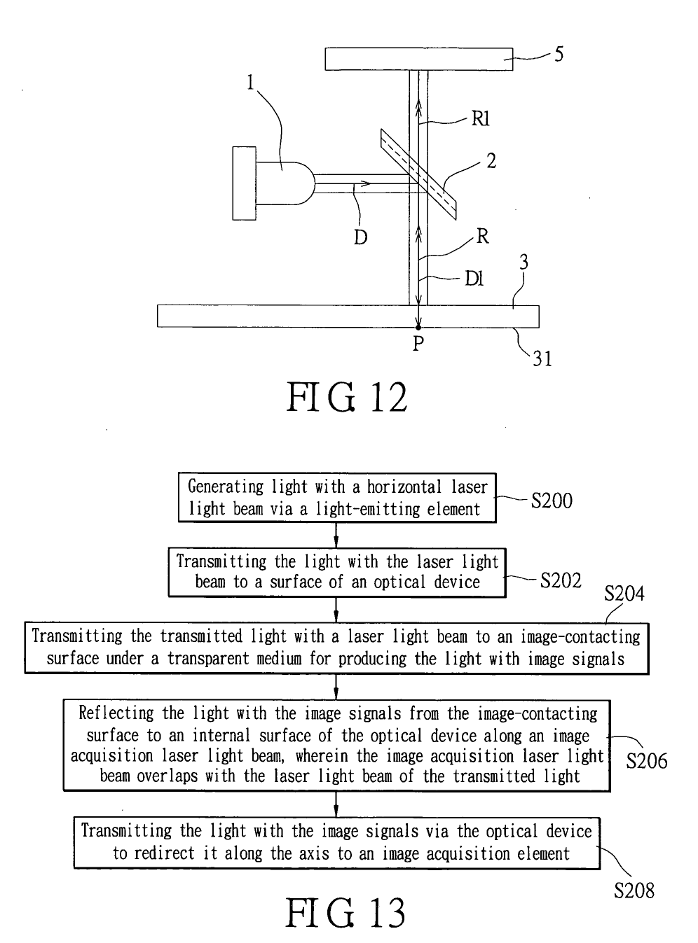

FIGS. 12 and 13 show a schematic view and a flowchart of the second embodiment according to the present invention, respectively. The second embodiment shows an optical image acquisition method, as outlined below:

1. Generating light with a horizontal laser light beam D via a light-emitting element 1 (S200), where the light-emitting element 1 can be a light-emitting diode;

2. Transmitting the light with the laser light beam D to a surface of an optical device 2 (S202), wherein the light can be split into reflected light and transmitted light by the optical device 2;

3. Transmitting the transmitted light with a laser light beam D1 to an image-contacting surface 31 under a transparent medium 3 for producing the light with image signals (S204), wherein the transparent medium can be glass;

4. Reflecting the light with the image signals from the image-contacting surface 31 to an internal surface of the optical device 2 along an image acquisition laser light beam R, wherein the image acquisition laser light beam R overlaps with the laser light beam D1 of the transmitted light (S206); and

5. Transmitting the light with the image signals via the optical device 2 to redirect it along the axis R1 to an image acquisition element 5 (S208), wherein the image acquisition element 5 can be a CCD or CIS.

Because the laser light beam D1 and the image acquisition laser light beam R overlap and intersect with a point P of the image-contacting surface 31, images can be correctly acquired by the image acquisition element 5.

Therefore, optical devices may operate normally on transparent media 3 and the image acquisition element 5 can retrieve the images reflected from the transparent media 3. Furthermore, movement and directions made by the optical mouse are calculated by control units.

The present invention further provides an optical image acquisition method using an optical device and a reflecting mirror, as outlined below:

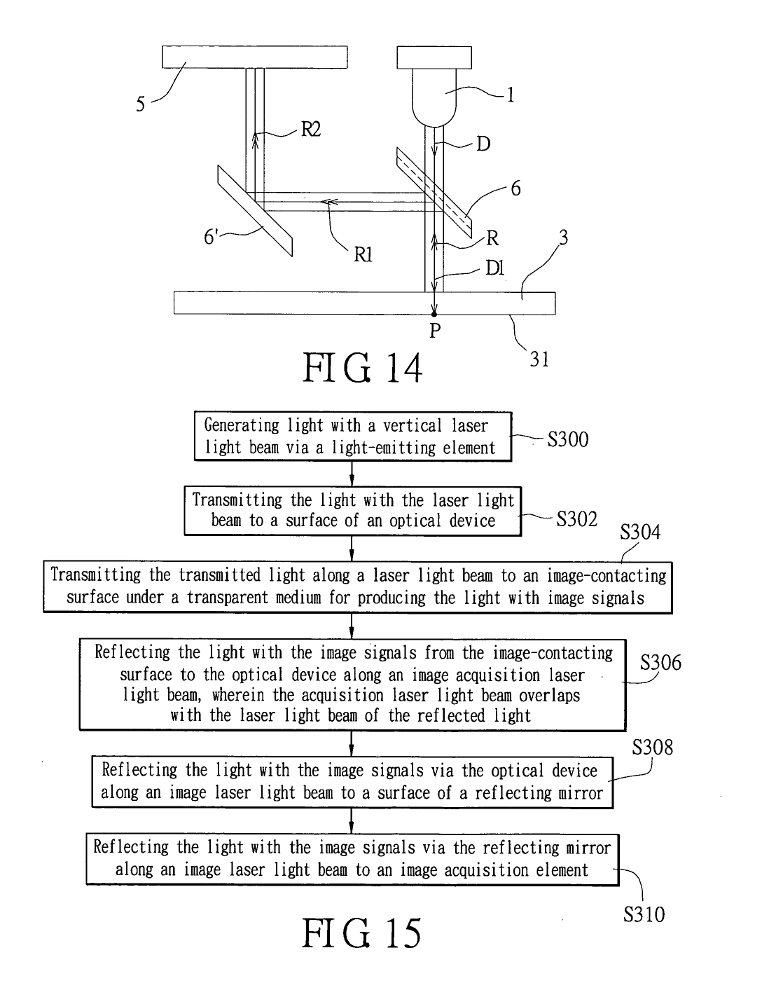

FIGS. 14 and 15 show a schematic view and a flowchart of the third embodiment according to the present invention. The third embodiment shows an optical image acquisition method, and it provides following steps:

1. Generating light with a vertical laser light beam D via a light-emitting element 1 (S300), wherein the light-emitting element 1 can be a light-emitting diode;

2. Transmitting the light with the laser light beam D to a surface of an optical device 6 (S302), wherein the light can be split into reflected light and transmitted light by the optical device 6;

3. Transmitting the transmitted light along a laser light beam D1 to an image-contacting surface 31 under a transparent medium 3 for producing the light with image signals (S304), wherein the transparent medium can be glass;

4. Reflecting the light with the image signals from the image-contacting surface 31 to the optical device 6 along an image acquisition laser light beam R, wherein the acquisition laser light beam R overlaps with the laser light beam D1 of the reflected light (S306);

5. Reflecting the light with the image signals via the optical device 6 along an image laser light beam R1 to a surface of a reflecting mirror 6′ (S308); and

6. Reflecting the light with the image signals via the reflecting mirror 6′ along an image laser light beam R2 to an image acquisition element 5 (S310).

Because the laser light beam D1 and the image acquisition laser light beam R overlap and intersect with a point P of the image-contacting surface 31, images can be correctly acquired by the image acquisition element 5.

Therefore, optical devices may operate normally on the transparent media 3 and the image acquisition element 5 can retrieve the images reflected from the transparent media 3. Furthermore, movement and directions made by the optical mouse are calculated by control units.

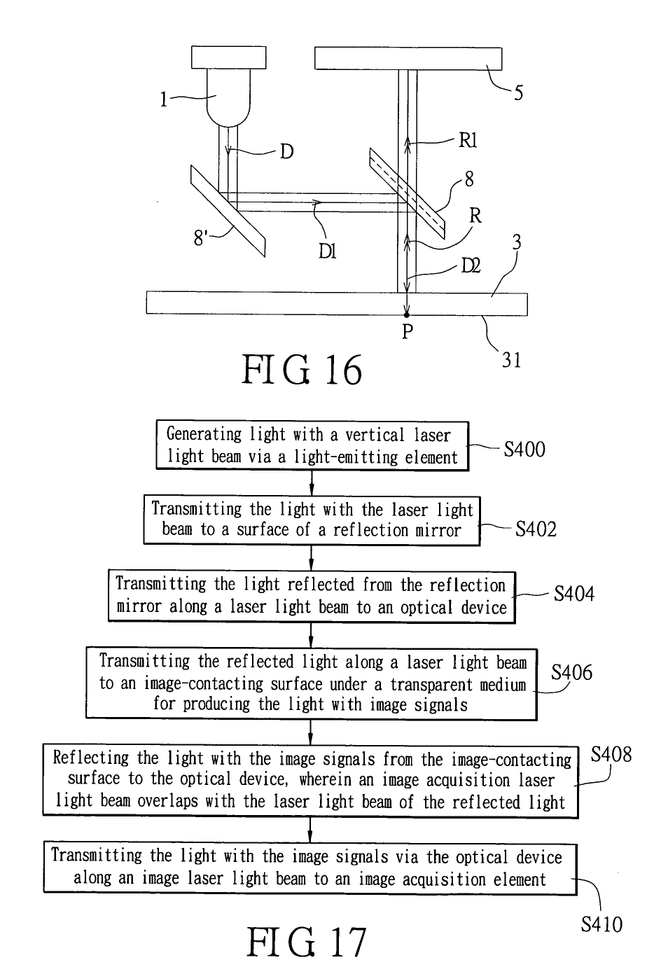

FIGS. 16 and 17 show a schematic view and a flowchart of the fourth embodiment according to the present invention, respectively. The fourth embodiment shows an optical image acquisition method, as outlined below:

1. Generating light with a vertical laser light beam D via a light-emitting element 1 (S400), wherein the light-emitting element 1 can be a light-emitting diode;

2. Transmitting the light with the laser light beam D to a surface of a reflection mirror 8′ (S402);

3. Transmitting the light reflected from the reflection mirror 8′ along a laser light beam D1 to an optical device 8 (S404), wherein the light can be split into reflected light and transmitted light by the optical device 8;

4. Transmitting the reflected light along a laser light beam D2 to an image-contacting surface 31 under a transparent medium 3 for producing the light with image signals (S406), wherein the transparent medium can be glass;

5. Reflecting the light with the image signals from the image-contacting surface 31 to the optical device 8, wherein an image acquisition laser light beam R overlaps with the laser light beam D2 of the reflected light (S408); and

6. Transmitting the light with the image signals via the optical device 8 along an image laser light beam R1 to an image acquisition element 5 (S410).

Because the laser light beam D2 and the image acquisition laser light beam R overlap and intersect with a point P of the image-contacting surface 31, images can be acquired by the image acquisition element 5.

Therefore, optical devices may operate normally on the transparent media 3 and the image acquisition element 5 can retrieve the images reflected from the transparent media 3. Moreover, movement and directions made by the optical mouse are calculated by control units.

The present invention combines an optical device and a reflecting mirror into a single element for providing an optical image acquisition method, as outlined below:

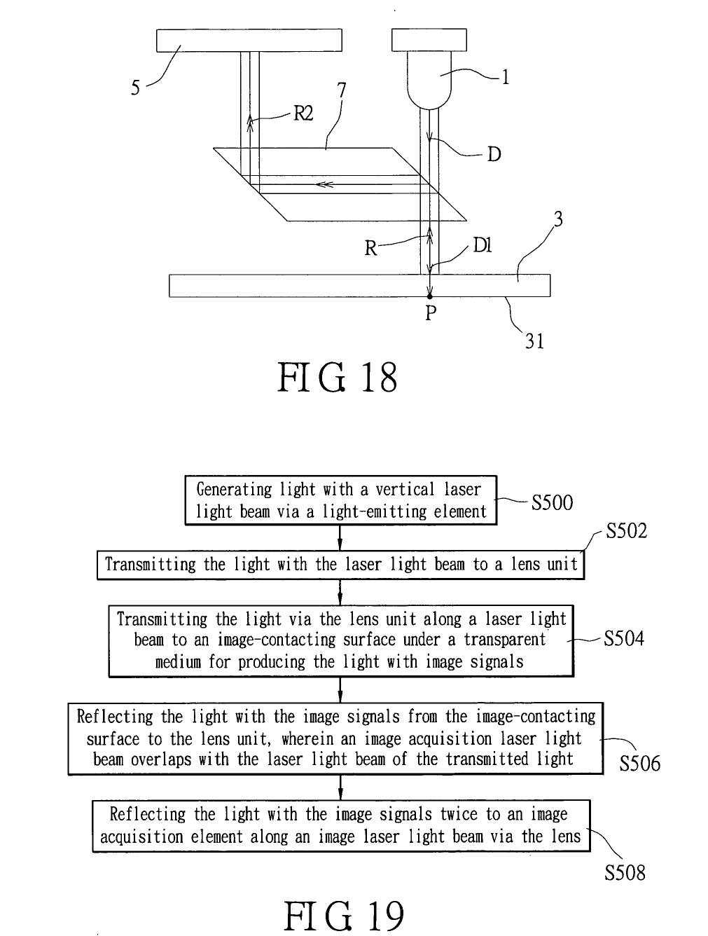

FIGS. 18 and 19 show a schematic view and a flowchart of the fifth embodiment according to the present invention. The fifth embodiment shows an optical image acquisition method, as outlined below:

1. Generating light with a vertical laser light beam D via a light-emitting element 1 (S500), wherein the light-emitting element 1 can be a light-emitting diode;

2. Transmitting the light with the laser light beam D to a lens unit 7 (S502);

3. Transmitting the light via the lens unit 7 along a laser light beam D1 to an image-contacting surface 31 under a transparent medium 3 for producing the light with image signals (S504), wherein the transparent medium can be glass;

4. Reflecting the light with the image signals from the image-contacting surface 31 to the lens unit 7, wherein an image acquisition laser light beam R overlaps with the laser light beam D1 of the transmitted light (S506); and

5. Reflecting the light with the image signals twice to an image acquisition element 5 along an image laser light beam R2 via the lens 7 (S508), wherein the image acquisition element 5 can be a CCD or CIS.

Because the laser light beam D1 and the image acquisition laser light beam R overlap and intersect with a point P of the image-contacting surface 31, images can be acquired correctly by the image acquisition element 5.

Therefore, optical devices may operate normally on the transparent media 3 and the image acquisition element 5 can retrieve the images reflected from the transparent medium 3. Moreover, movement and directions made by the optical mouse are calculated by control units.

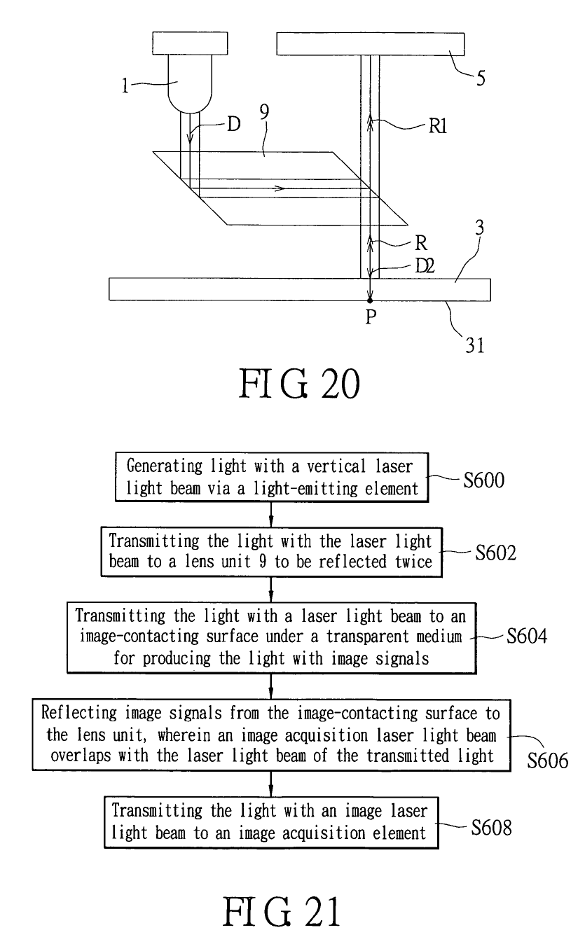

FIGS. 20 and 21 show a schematic view and a flowchart of the sixth embodiment according to the present invention. The sixth embodiment shows an optical image acquisition method, as outlined below:

1. Generating light with a vertical laser light beam D via a light-emitting element 1 (S600), wherein the light-emitting element 1 can be a light-emitting diode;

2. Transmitting the light with the laser light beam D to a lens unit 9 to be reflected twice (S602);

3. Transmitting the light with a laser light beam D2 to an image-contacting surface 31 under a transparent medium 3 for producing the light with image signals (S604), wherein the transparent medium can be glass;

4. Reflecting image signals from the image-contacting surface 31 to the lens unit 9, wherein an image acquisition laser light beam R overlaps with the laser light beam D2 of the transmitted light (S606); and

5. Transmitting the light with an image laser light beam R1 to an image acquisition element 5 (S608), wherein the image acquisition element 5 can be a CCD or CIS.

Because the laser light beam D2 and the image acquisition laser light beam R overlap and intersect with a point P of the image-contacting surface 31, images can be acquired by the image acquisition element 5.

Therefore, optical devices may operate normally on the transparent media 3 and the image acquisition element 5 can retrieve the images reflected from the transparent media 3. Additionally, movement and directions made by the optical mouse are calculated by control units.

Furthermore, media of the above-mentioned image-contacting surface 31, such as, for example, paper, plated object, printing images, and carvings, can be set between two transparent elements, such as glass.

Additionally, an optical device/the optical device of the present invention can operate on transparent media and also on non-transparent media. Moreover, the optical device (6 or 8), the reflecting mirror (6′ or 8′) or the lens unit (7 or 9) is used to decrease the intensity of the laser light beam lessening the damage caused to a user's eyes when the user looks steadily at the laser light beam. Furthermore, the image acquisition element 5 has a compact sensor array due to the progress of the image-sensing element. In other words, the image acquisition element 5 of the present invention has a greater number of pixels arranged thereon than that of the prior art image acquisition element which was the same size. Hence, the image acquisition element 5 can be used to acquire images by itself without using any lenses to focus image signals as in the prior art, and the present invention is cheaper due to lack the lens.

Although the present invention has been described with reference to the preferred embodiment therefore, it will be understood that the invention is not limited to the details thereof. Various substitutions and modifications have suggested in the foregoing description, and others will occur to those of ordinary skill in the art. Therefore, all such substitutions and modifications are intended to be embraced within the scope of the invention as defined in the appended claims.

What is claimed is:

1. An optical image acquisition method adapted to a laser optical mouse for detecting image signals reflected from an image-contacting surface under a medium, the method comprising:
generating a laser light projected in a vertical direction;
transmitting the laser light to an optical device;
transmitting the laser light through the optical device and transmitting a transmitted laser light passing through the optical device to the image-contacting surface under the medium for producing the image signals;
reflecting the image signals to the optical device along an image acquisition laser light beam, wherein the image acquisition laser light beam overlaps with a laser light beam of the transmitted laser light; and
reflecting the image signals returned from the image-contacting surface to an image acquisition element.

2. The optical image acquisition method as in claim 1, wherein the medium is a transparent medium that is glass.

3. The optical image acquisition method as in claim 1, wherein the medium is a non-transparent medium.

4. An optical image acquisition method adapted to laser optical mouse, comprising:
generating a laser light and projecting the laser light in a vertical direction;
transmitting the laser light to an optical device;
transmitting the laser light reflected by the optical device at least once to an image-contacting surface under a medium;
reflecting image signals to the optical device, wherein an image acquisition laser light beam overlaps with a laser light beam of laser light reflected by the optical device; and
transmitting the image signals returned from the image-contacting surface to an image acquisition element.

5. The optical image acquisition method as in claim 4, wherein the medium is a transparent medium that is a glass.

6. The optical image acquisition method as in claim 4, wherein the medium is a non-transparent medium.

7. An optical image acquisition method adapted to laser optical mouse, comprising:
generating a laser light and projecting the laser light in a horizontal direction;
transmitting the laser light to an optical device;
transmitting laser light reflected by the optical device to an image-contacting surface under a medium;
reflecting image signals onto the optical device, wherein an image acquisition laser light beam overlaps with a laser light beam of laser light reflected by the optical device; and
transmitting image signals returned from the image-contacting surface to an image acquisition element.

8. The optical image acquisition method as in claim 7, wherein the medium is a transparent medium that is a glass.

9. The optical image acquisition method as in claim 7, wherein the medium is a non-transparent medium.

10. An optical image acquisition method adapted to laser optical mouse, comprising:
generating a laser light and projecting the laser light in a horizontal direction;
transmitting the laser light to a lens unit;
transmitting the laser light reflected by the lens unit twice to an image-contacting surface under a medium;
reflecting image signals to the lens unit, wherein an image acquisition laser light beam overlaps with the laser light beam of the laser light reflected twice by the lens unit; and
transmitting laser light returned from the image-contacting surface to an image acquisition element.

11. The optical image acquisition method adapted to a laser optical mouse as in claim 10, wherein the medium is a transparent medium that is a glass.

12. The optical image acquisition method adapted to a laser optical mouse as in claim 10, wherein the medium is a non-transparent medium.
